(19) United States
(12) Patent Application Publication
(10) Pub. No.: US 2023/0263135 A1
(43) Pub. Date: Aug. 24, 2023

(54) DRONE FOR HERDING HERD ANIMALS

(71) Applicant: BEEFREE AGRO LTD., Rosh Pina (IL)

(72) Inventors: Noam Yaacov Azran, Kibbutz Hukok (IL); Dvir Cohen, Rosh Pina (IL)

(21) Appl. No.: 18/014,490

(22) PCT Filed: Jul. 7, 2021
(86) PCT No.: PCT/IL2021/050836

§ 371 Date: Jan. 5, 2023

Related U.S. Application Data
(60) Provisional application No. 63/048,816, filed on Jul. 7, 2020.

(51) Int. Cl. A01K 15/00; G05D 1/10; B64U 10/00

(52) U.S. Cl. CPC A01K 15/003; B64U 10/00; G05D 1/101; B64U 2101/30

(57) ABSTRACT

A system (30) for herding herd animals, the system comprising: a database (33) comprising executable instructions for each of a plurality of herding gestures that are executable by a drone to control movement of a herd of animals; and at least one drone (80) having a controller comprising a processor operable to execute the instructions to control the at least one drone to perform the gestures and autonomously control the herd.

### RELATED APPLICATIONS

The present application claims the benefit under 35 U.S.C. 119(e) of U.S. Provisional Application 63/048,816 filed on Jul. 7, 2020 the disclosure of which is incorporated herein by reference.

### FIELD

Embodiments of the disclosure relate to providing a drone system for herding animals.

### BACKGROUND

Animal husbandry involving the herding domestic animals such as cows or sheep is a socially complex activity typically involving communication and cooperation between three or four different types of social mammals: men; trained canines; the herded animals; and horses if the men are on horseback. The activity generally involves learned patterns of communications between the herd animals, attendant dogs, horses, and men, and their joint synchronized movement, often over relatively large distances and difficult terrain that are negotiated at least on part by land vehicle and/or aircraft. The activity regularly requires long hours of alert, but often monotonous, work and attention to detail, and may be a relatively expensive component of the costs of a financial return provided by the husbandry.

### SUMMARY

An aspect of an embodiment of the disclosure relates to providing a herd management (HeMan) system, also referred to simply as “HeMan”, comprising an optionally cloud based control and data hub and at least one drone with which the hub communicates that may operate autonomously or semi-autonomously to control movement of a herd of animals.

In an embodiment HeMan is configured to receive assignment of a herding task such as moving a herd of animals from a first location to a second location and operate to deploy at least one drone, optionally referred to as a “drone cowboy”, that may autonomously herd the animals from the first location to the second location. In an embodiment the HeMan hub comprises or has access to a telecommunications system for communication with the drone cowboy and for receiving location data transmitted from an animal in the herd that may be tagged with a radio transmitter and a GPS receiver.

In an embodiment the hub comprises a memory storing a terrain map of a geographical region of interest (GROI) in which the herd may be located and a drone herding gesture (DHG) data base. The DHG data base may comprise a library of herding gestures that a drone cowboy may perform to control movement of a herd. A herding gesture may comprise at least one or any combination of more than one of an aerobatic maneuver, an acoustic gesture, or an optical gesture that a drone cowboy may perform to control herd movement. An aerobatic maneuver comprises a formatted gesture flight pattern intended to elicit a particular type of movement by a herd or an animal in a herd. An acoustic gesture may comprise by way of example, a barking noise made by a herd dog, a vocalization made by a cowboy, or an artificial noise made to herd an animal or animals. An optical gesture may comprise a visual light stimulus that elicits a desired response from a herd or herd animal.

In an embodiment, the at least one drone cowboy comprises a radio transceiver for communicating with the HeMan hub, a GPS receiver and/or optionally an inertial measurement unit (IMU) for determining location of the drone, a camera, and a controller operable to control flight of the drone cowboy. In an embodiment, the controller comprises a memory for storing a terrain map of the GROI, coordinates of landmarks and/or locations of animals relevant to the herding assignment, and/or a herding flight plan, optionally at least partially preplanned, for carrying out the herding assignment. The flight plan optionally comprises a sequence of herding gestures to be synchronized with execution of the flight plan by the at least one drone cowboy.

In an embodiment a herding flight plan may be dynamically updated during execution of the herding assignment responsive to behaviour of the herded animals, unknown features in the GROI and/or changes in the GROI. To facilitate monitoring and real time updating of performance of the herding task, the at least one drone cowboy may be configured to image the animals being herded and/or the terrain in which the animals are located and process the images and/or transmit the images for processing by the HeMan hub to update the herding flight plan. A flight plan may be determined by a user, the HeMan hub, and/or the controller of the at least one drone cowboy.

In accordance with an embodiment of the disclosure, HeMan may comprise a neural network that learns to refine performance of HeMan in carrying out herding assignments based on HeMan experience in carrying out such assignments. For example, for a given herd of animals the neural network may learn which herding gestures, or features of herding gestures are advantageous in eliciting desires responses from herded animals. Additionally, or alternatively, the neural network may learn to distinguish particular features of the GROI landscape which are conducive to or interfere with efficient herding of the herded animals.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale

FIGS. 1A-1O schematically illustrate various herding gestures (DHGs) that a drone cowboy may use to control movement of a herd, in accordance with an embodiment of the disclosure;

FIG. 2 schematically shows a HeMan system and a terrain in which a herd of animals for which HeMan is tasked with herding to a corral is dispersed, in accordance with an embodiment of the disclosure;

FIG. 3 shows a flow diagram of a procedure that He-Man may execute to determine a herding plan for using a drone cowboy to herd the animals shown in FIG. 2 to the corral, in accordance with an embodiment of the disclosure;

FIG. 4 shows a schematic of a herding plan route and associated waypoints that HeMan determines for driving the herd shown in FIG. 2 to the corral, in accordance with an embodiment of the disclosure;

FIGS. 5A-5H schematically show a drone cowboy executing the herding plan shown in FIG. 3B, in accordance with an embodiment of the disclosure;

### DETAILED DESCRIPTION

In the discussion, unless otherwise stated, adjectives such as “substantially” and “about” modifying a condition or relationship characteristic of a feature or features of an embodiment of the disclosure are understood to mean that the condition or characteristic is defined to within tolerances that are acceptable for operation of the embodiment for an application for which the embodiment is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. The phrase “in an embodiment”, whether or not associated with a permissive, such as “may”, “optionally”, or “by way of example”, is used to introduce for consideration an example, but not necessarily a required configuration of a possible embodiment of the disclosure. Unless otherwise indicated, the word “or” in the description and claims is considered to be the inclusive “or” rather than the exclusive or, and indicates at least one of, or any combination of more than one of items it conjoins.

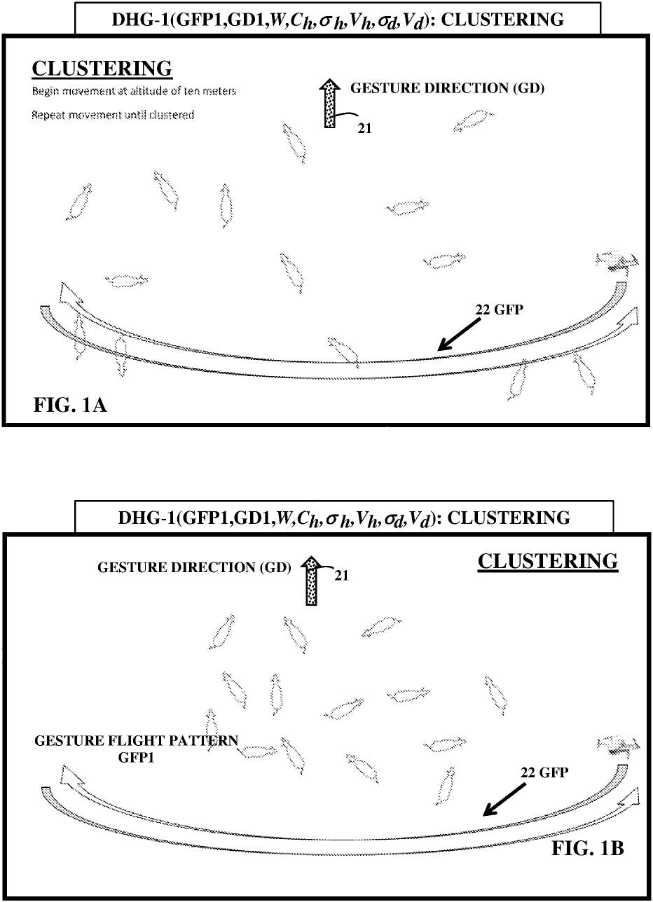

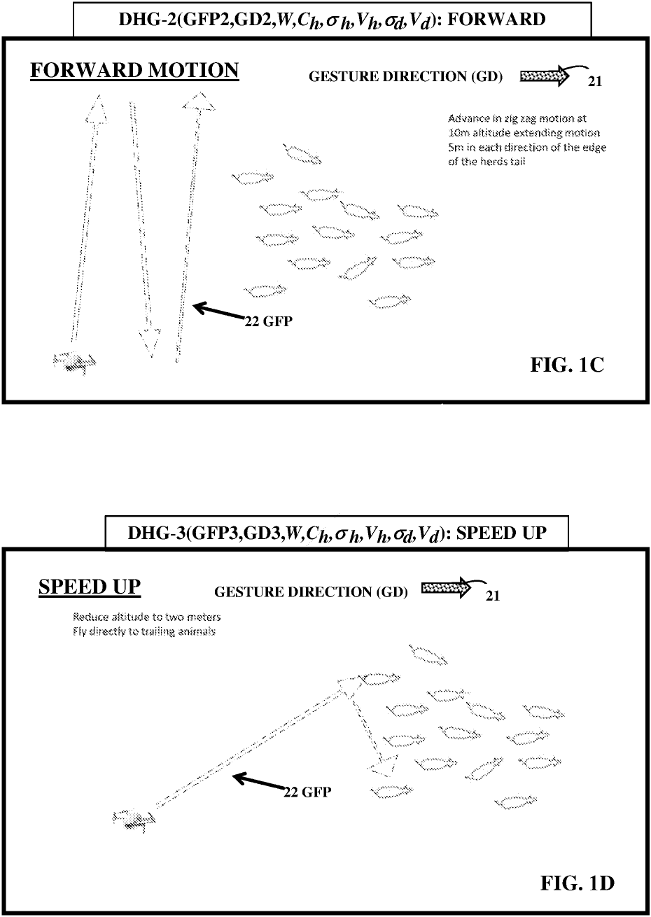

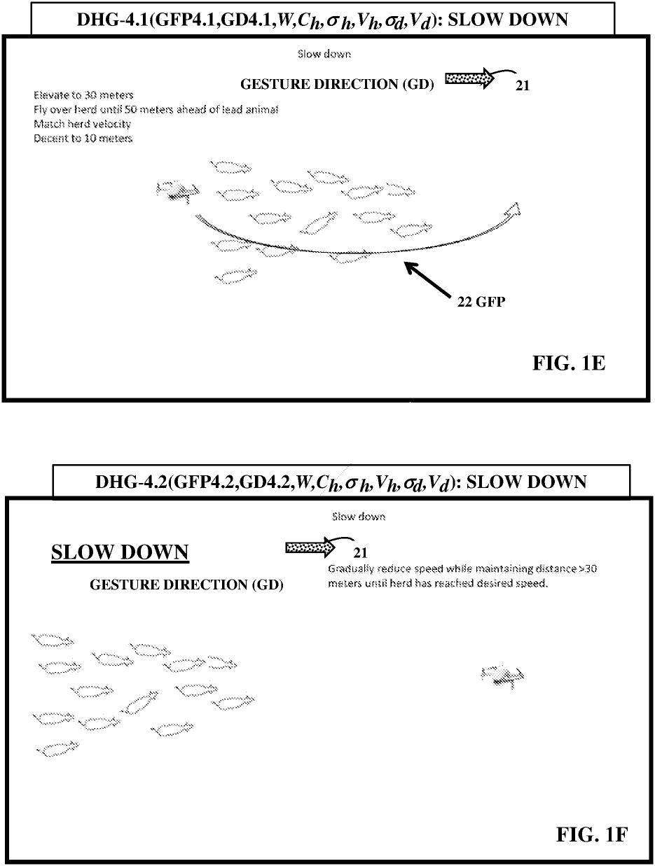

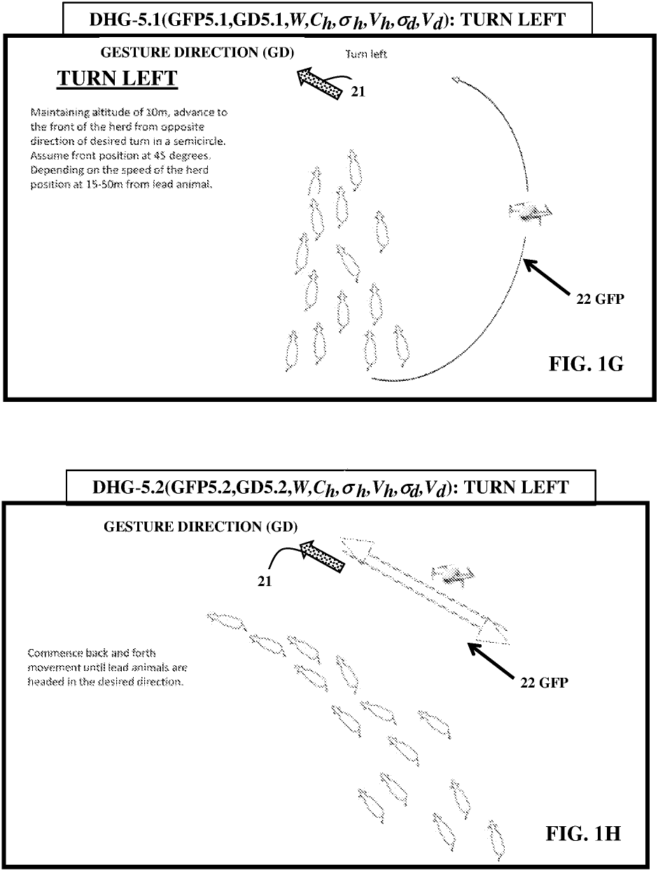

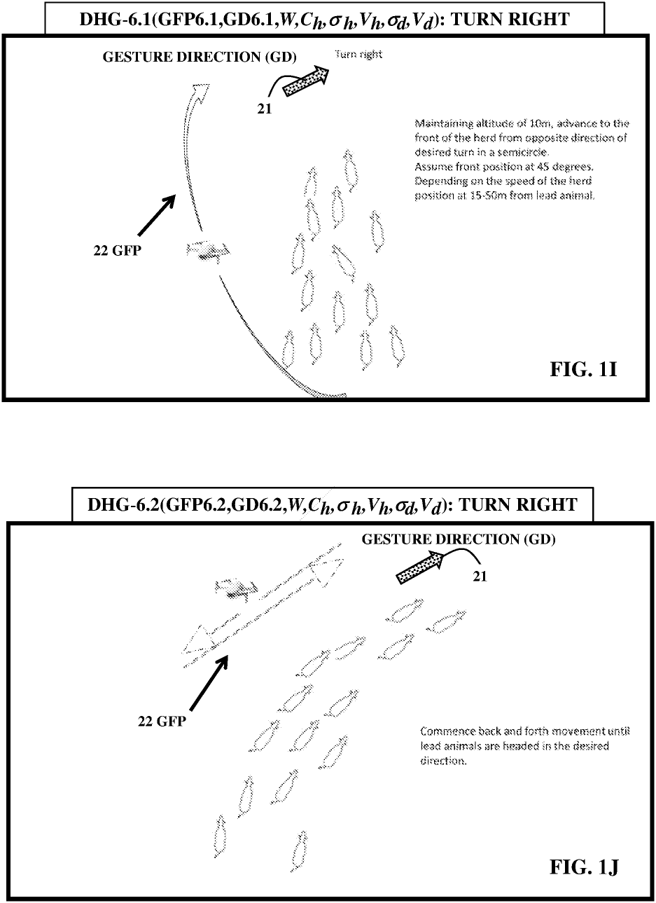

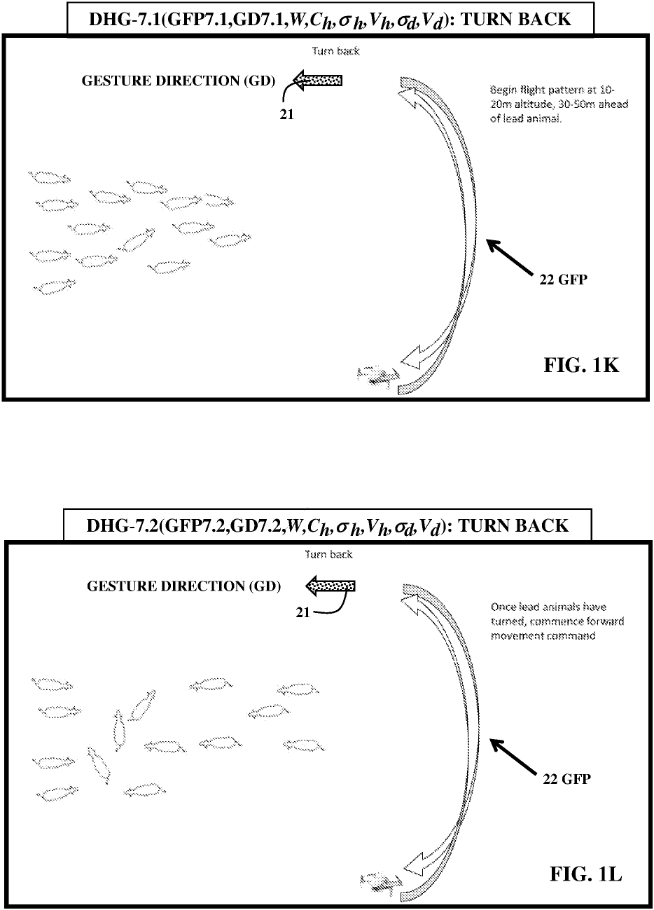

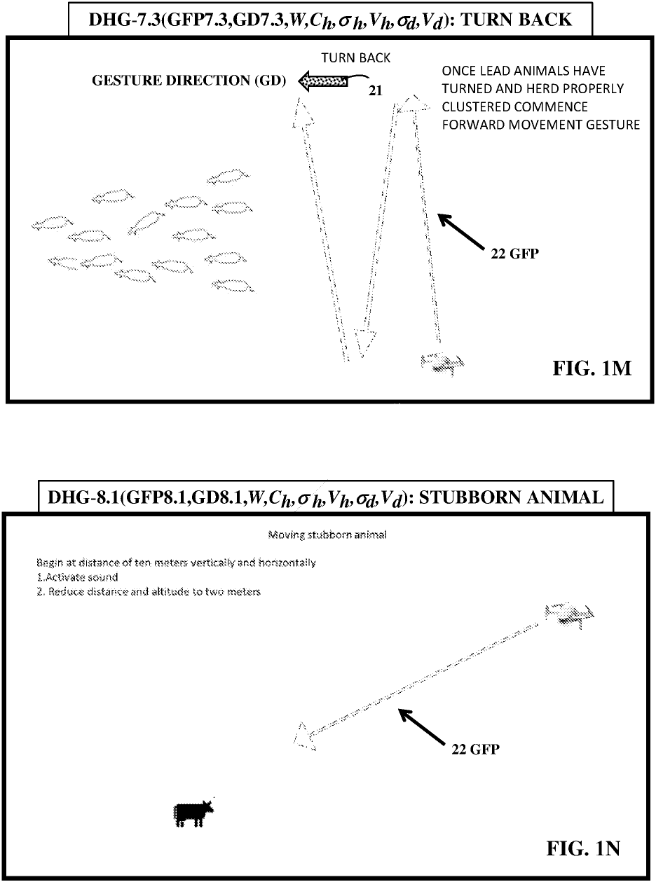

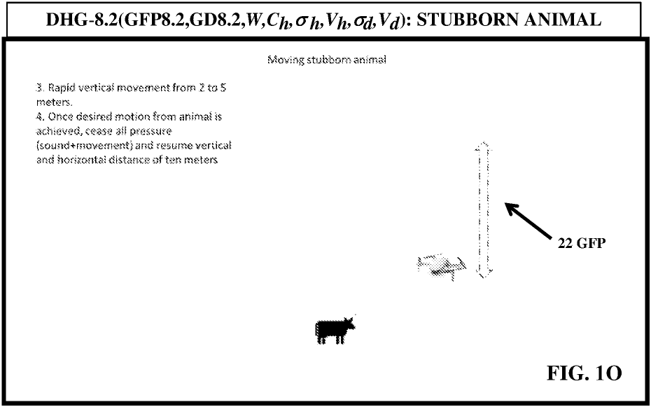

FIGS. 1A - 1O schematically illustrate a selection of HeMan drone herding gestures “DHGs”, that may be stored in a database of the HeMan control and data hub and/or in a memory of a HeMan drone cowboy that the drone cowboy may employ to control movement of a herd and/or herd animal in accordance with an embodiment of the disclosure. Each DHG is identified by the acronym DHG followed by a dash and a distinguishing numerical ID, and is optionally a function of arguments comprising a set of static arguments that identify and configure the DHG, and a set of dynamic, input arguments that are used to determine how and when during execution of a drone herding flight the DHG may be applied. The static and dynamic arguments relevant to a given drone herding gesture DHG in accordance with an embodiment are given in parenthesis following the gesture ID.

The static parameters of a DHG may include a gesture flight pattern “GFP” followed by the numerical ID of the DHG, and an intended gesture direction “GD” followed by the numerical ID of the DHG. The flight pattern, “GFP”, of a given DHG may comprise a set of executable instructions which when executed by an onboard controller of a HeMan drone cowboy cause the drone cowboy to engage in a particular flight pattern intended to elicit a particular response from a herd or herd animal. The intended gesture direction GD of a given DHG is a direction of motion of a herd or herd animal that the given gesture is intended to generate or affect. A GD is substantially fixed with respect to a geometry of the given gesture’s flight pattern and may be defined by a unit vector having a fixed direction relative to a direction of the gesture flight pattern GFP. In each figure the gesture direction GD is indicated by a patterned block arrow labeled “GESTURE DIRECTION (GD)” and indicated by a numerical label “21”. The associated gesture flight pattern is labeled “GFP” and indicated by a numerical label “22”.

A DHG for which the GFP comprises a sequence of distinct component flight movements is represented by a plurality of component DHG functions. Each component DHG function belonging to a same DHG is identified by a decimal ID number having a same number to the left of the decimal and a different number to the right of the decimal. The number to the left of the decimal is used to reference the DHG and generically reference the component DHG functions. The increasing order of the numbers to the right of the decimal indicate the sequence in which the distinct flight movements belonging to the DHG component functions are performed.

Dynamic arguments for a given DHG are shown in italicized script and may include a location of a waypoint “W” along a drone cowboy flight path at which a drone cowboy flying the flight path operates to gesture to a herd by performing the given DHG. The dynamic arguments include arguments that characterise location and movement of the herd gestured to and desired movement and/or location of the herd to be achieved by preforming the gesture. A centroid “Cₕ” determined for locations of herd animals in the herd and a measure of dispersion “σₕ” of the locations may be used to characterize location of the herd. A velocity “Vₕ” of the centroid may be used to characterize motion of the herd. A desired velocity of the centroid, “V_{d}”, may be used to characterize a desired movement of the herd and “σ_{d}” a desired spatial dispersion to be achieved by the DHG.

By way of example, DHG-1 shown in FIG. 1A is a drone herd gesture that a HeMan drone cowboy may execute when located at a given waypoint W of a herding flight path in accordance with an embodiment to cluster a herd determined to be overly spatially dispersed. In an embodiment HeMan may determine that a herd is overly dispersed if dispersion σₕ for the herd is greater than a predetermined upper limit ULM(σₕ). A gesture flight pattern GFP 22 intended to cluster the herd in accordance with DHG-1 in the event that σₕ is greater than ULM(σₕ) may be characterized by an arc shape having an arc length and radius of curvature (not shown). Gesture flight pattern GFP 22 has a gesture direction pointing substantially from a center of the arc length of the gesture flight pattern toward a center of curvature of the arc. In an embodiment the HeMan drone cowboy may execute DHG-1 until herd dispersion σₕ is less than or equal to about ULM(σₕ) or a desired herd dispersion σ_{d}. To facilitate clustering, the drone cowboy may reduce radius of curvature of the arc flight pattern 22 and/or change direction 21 of the flight pattern during execution of DHG-1 until the herd is clustered as desired.

In an embodiment HeMan may determine that σₕ ≥ ULM(σₕ) and monitor progress in clustering the herd based on processing data comprised in GPS locations received by the HeMan hub and/or the drone cowboy from herd animals and/or data in images of the herd acquired by a camera system that the drone cowboy may comprise. Processing data provided by the GPS locations and/or the herd images may be preformed by a processor or processors that the HeMan hub and/or drone cowboy comprises or has access to.

By way of another example, DHG-5 performed at a waypoint W by a HeMan drone cowboy to gesture to a herd to turn left optionally comprises component drone herding gestures DHG-5.1 and DHG-5.2 shown in FIGS. 1G and 1H respectively. DHG-5.1 comprises an arc shaped flight pattern GFP5.1 that the drone cowboy flies on a right side of a herd and ends substantially at a front of the herd in a flight heading indicated by gesture direction GD5.1 block arrow 21 at about 45° to a motion vector Vₕ of the herd. Component gesture DHG-5.2 may follow component gesture DHG-5.1 and is a reinforcing gesture comprising a substantially straight line gesture flight pattern GFP5.2 that the drone cowboy may repeatedly fly in a direction the herd is intended to move after the left turn.

It is noted that whereas in the above description and FIGS. 1A-1O static arguments related to drone flight are discussed and shown, but as noted above static arguments may include non-flight arguments such as executable instructions for generating sounds and/or visual displays.

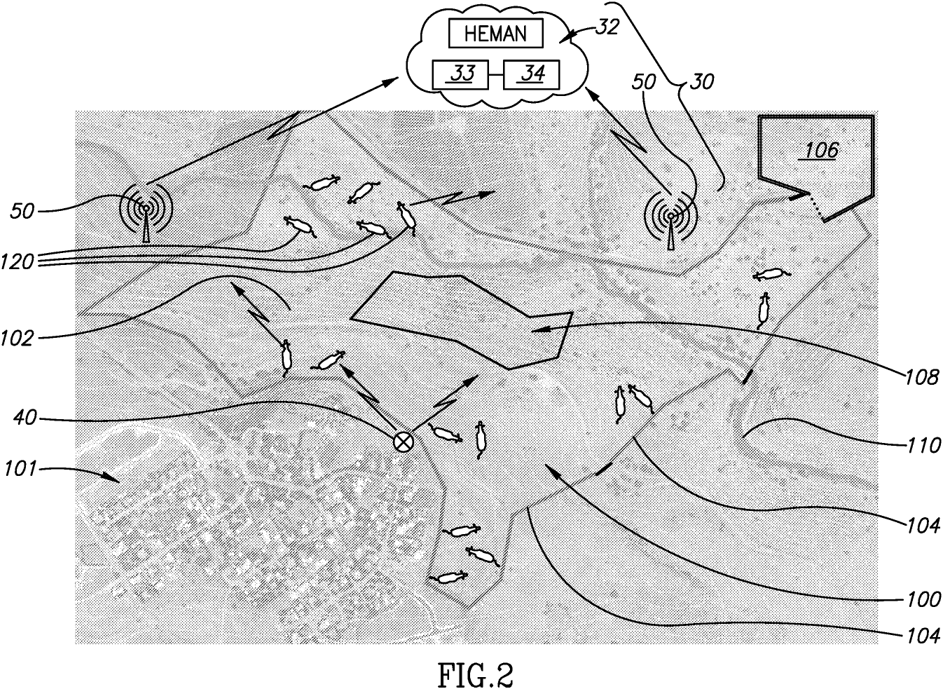

FIG. 2 schematically shows a HeMan system 30 in accordance with an embodiment of the disclosure deployed to herd animals in a geographical region of interest, GROI 100. GROI 100 is, shown by way of example, located near a town 101 and is characterized by a terrain 102 surrounded by a cattle fence 104, which opens to a cattle corral 106. A herd of animals 120 characterized by a relatively large dispersion σₕ is present in GROI 100. Terrain 102 comprises regions, such as a region 108, that exhibit relatively large slope gradients that are difficult for cattle to traverse, and a stream 110 that supports regions of relatively dense vegetation. HeMan system 30 optionally comprises a cloud based HeMan hub 32, a user station 40, and at least one communications tower 50 that supports wireless communications between hub 32, at least one HeMan drone cowboy (not shown in FIG. 2) user station 40, and/or GPS transceivers (not shown) attached to herd animals 120. Hub 32 comprises a memory 33 having data and/or executable instructions, hereinafter referred to as software, for use in supporting functions that HeMan provides for herding animals and a processor 34 configured to use the software to provide the functions. In an embodiment HeMan 30 comprises a DHG database comprising a selection of DHGs stored in memory 33 that processor 34 optionally uses to provide herding plans for herding animals and configuring a HeMan drone cowboy to execute the herding plans in accordance with an embodiment.

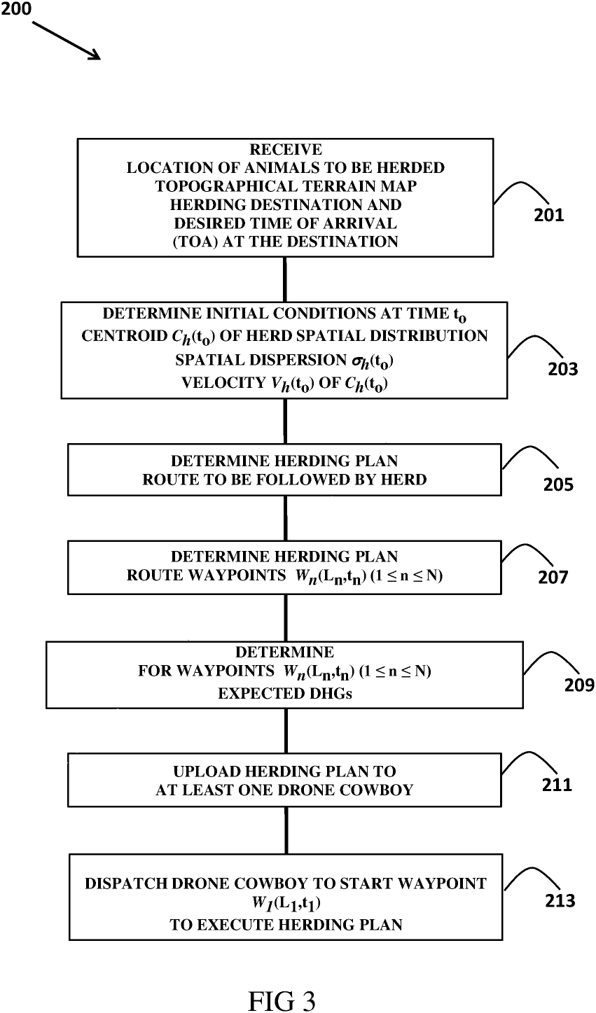

By way of example HeMan 30 is assigned with a task of herding cattle 120 to arrive at corral 106 by a desired time of arrival (TOA). In response to the assigned task, HeMan 30 operates to determine and execute a herding plan for performing the herding task. FIG. 3 shows a flow diagram 200 of a procedure, also referenced by the numeral 200, by which HeMan may operate to determine the herding plan.

In a block 201 of flow diagram 200 HeMan hub 30 receives the assignment to herd animals 120 in GROI 100 and receives or retrieves from memory 33 a terrain map for GROI 100, a location of corral 106 in the GROI, and/or a desired TOA of animals 120 at corral 106 and operates to determine locations of animals 120 in GROI 100. HeMan 30 may determine the locations of animal 120 by processing data comprised in signals transmitted by GPS transceivers attached to the animals to HeMan hub 32 via at least one communication tower 50. Additionally or alternatively, HeMan 30 may deploy a drone cowboy to scan and image GROI 100 and process images of the GROI received from the drone cowboy to determine the locations of the animals. Optionally in a block 203 HeMan 30 processes the determined locations of animal 120 to determine a centroid, Cₕ, dispersion σₕ, and velocity Vₕ for the herd.

In a block 205 HeMan 30 may use the determined values for Cₕ, σₕ, and Vₕ, the terrain map, and desired TOA of herd of animals 120 at corral 106, to determine a herding plan route to be traveled by animals 120 to reach corral 106.

To determine the herding route, HeMan 30 optionally identifies features of terrain 102 that are conducive to or present obstacles to movement of animals 120. For example, region 108 of terrain 102 is characterized by a steep terrain gradients may be difficult or dangerous for passage of herd animals 120 and may substantially slow movement of the herd animals. On the other hand, stream 100 may be conducive to herd movement and enable relatively rapid movement of herd animals along its banks while providing the animals with drinking water as they move. In an embodiment HeMan processor 33 may use a neural network to process data from the terrain map of terrain 102 to determine a herding plan route in GROI 100 for animals 120 to traverse to corral 106. Alternatively or additionally HeMan 30 may receive a suggested herding route from a user. Optionally HeMan comprises software executable to integrate route herding suggestions made by a user with herding route segments autonomously determined by HeMan to provide a herding route along which to drive animals 120 to corral 106.

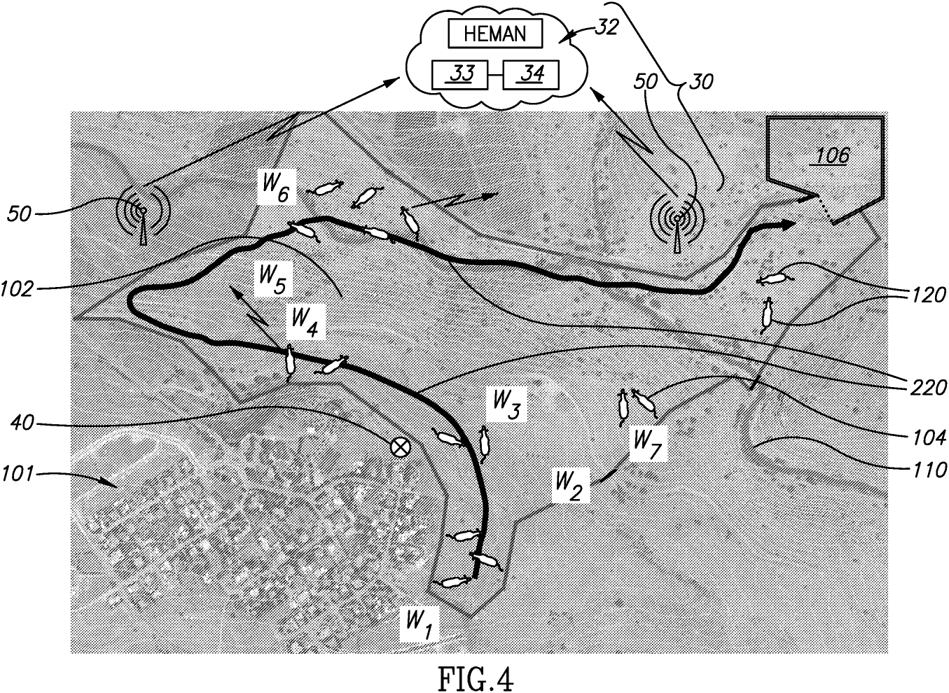

In a block 207 HeMan 30 optionally determines a plurality of N waypoints, Wₙ(Lₙ,tₙ), 1≤n≤N, at locations Lₙ along the herding plan route at which herd animals 120 may be expected to require intervention and suitable gesturing by at least one drone cowboy dispatched by HeMan to arrive at locations Lₙ at times tₙ to control movement of the animals along the route. In an embodiment, a first waypoint W₁(L₁,t₁) along the herding plan route is located at a starting location L₁ of the route at an estimated time of arrival t₁ of the dispatched drone cowboy to herd animals 120. A last waypoint W_{N}(L_{N},t_{N}) along the herding plan route is located at an end of the route substantially at the herding destination, corral 106, of animals 120 at a time t_{N} substantially equal to the desired TOA of animals 120 at the corral. Optionally, in a block 209 HeMan determines a flight plan according to which the dispatched drone cowboy is expected to fly to reach waypoints Wₙ(Lₙ,tₙ) and drone herding gestures, DHGs, the drone cowboy is planned to gesture to the animals at the waypoints. FIG. 4 schematically shows a herding plan route 220 having optionally nine waypoints 222 along the route indicated by diamond icon labels W₁ - W₇.

Optionally in a block 211 HeMan uploads the herding plan to at least one drone cowboy and in a block 213 optionally dispatches the at least one cowboy to arrive at waypoint W₁(L₁,t₁).

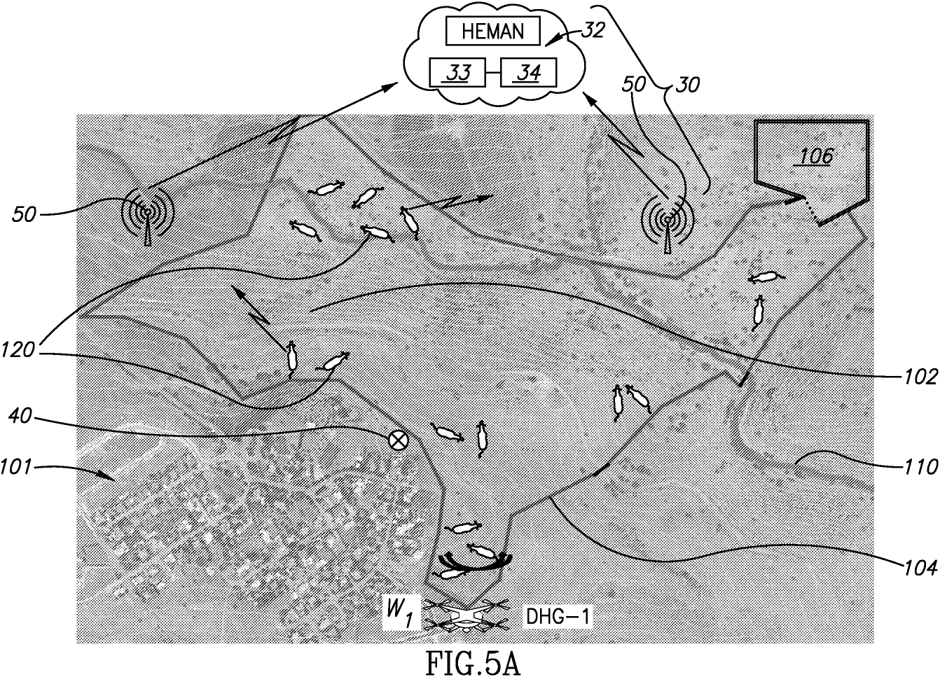

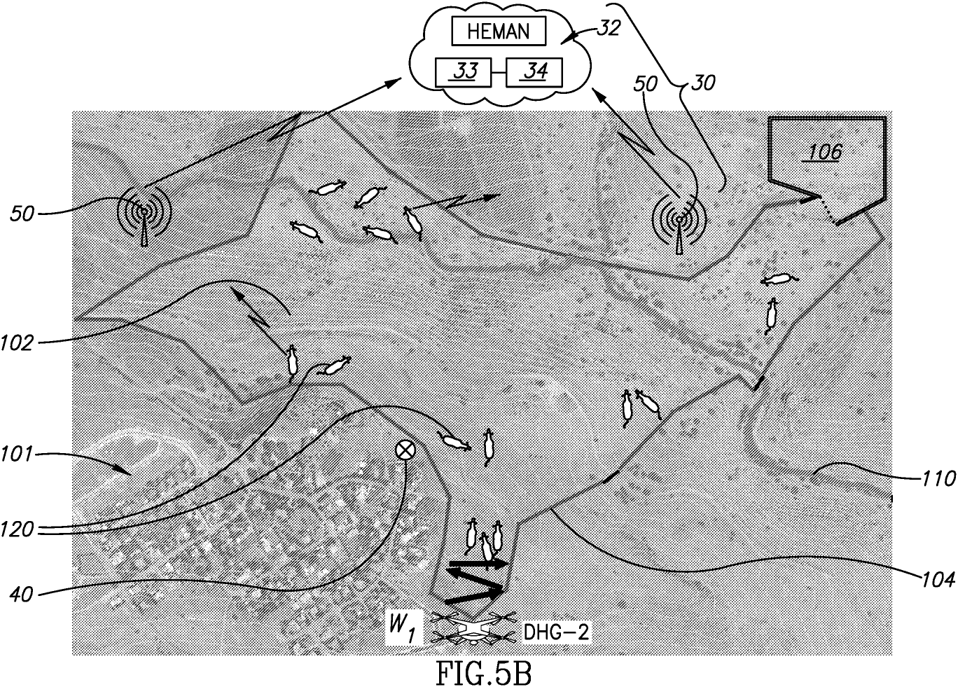

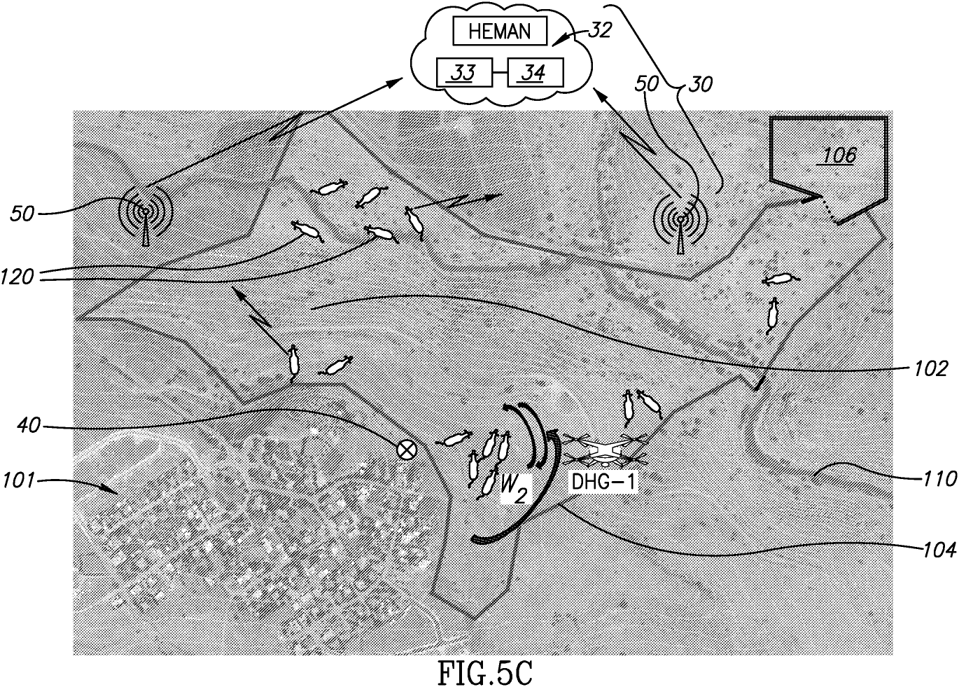

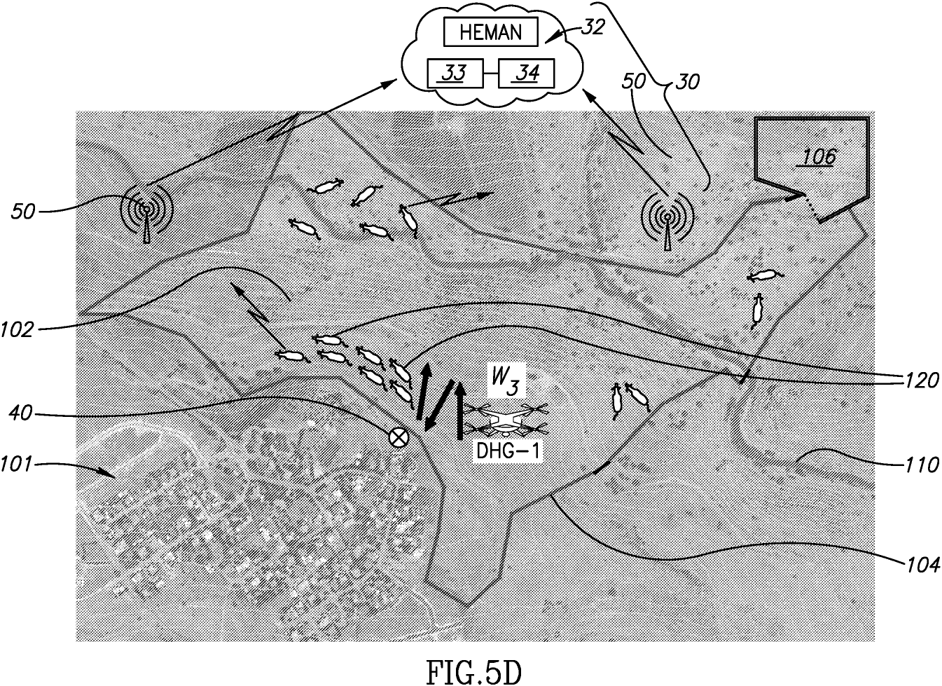

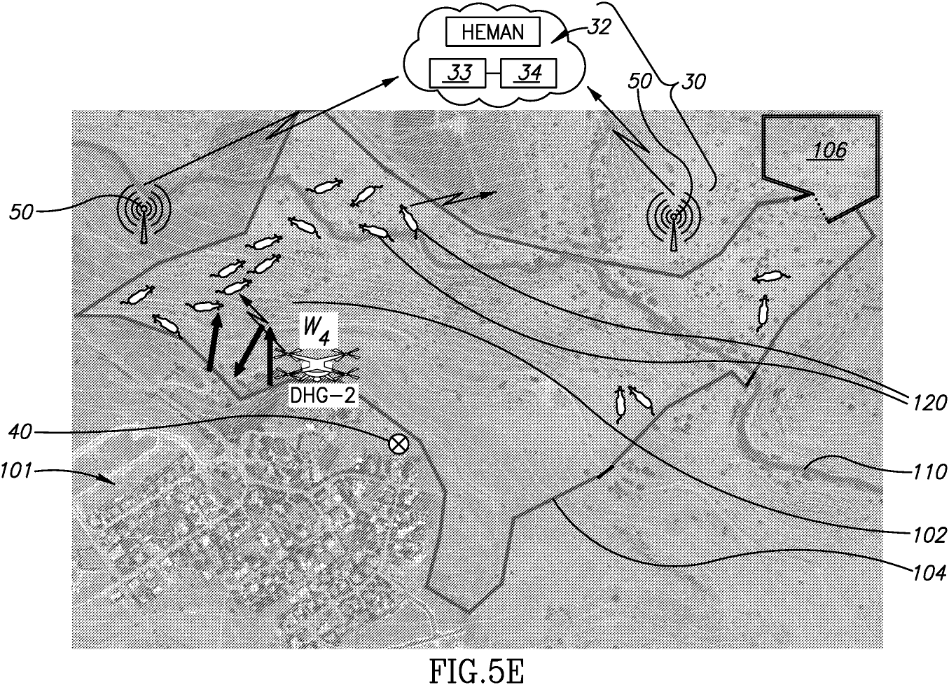

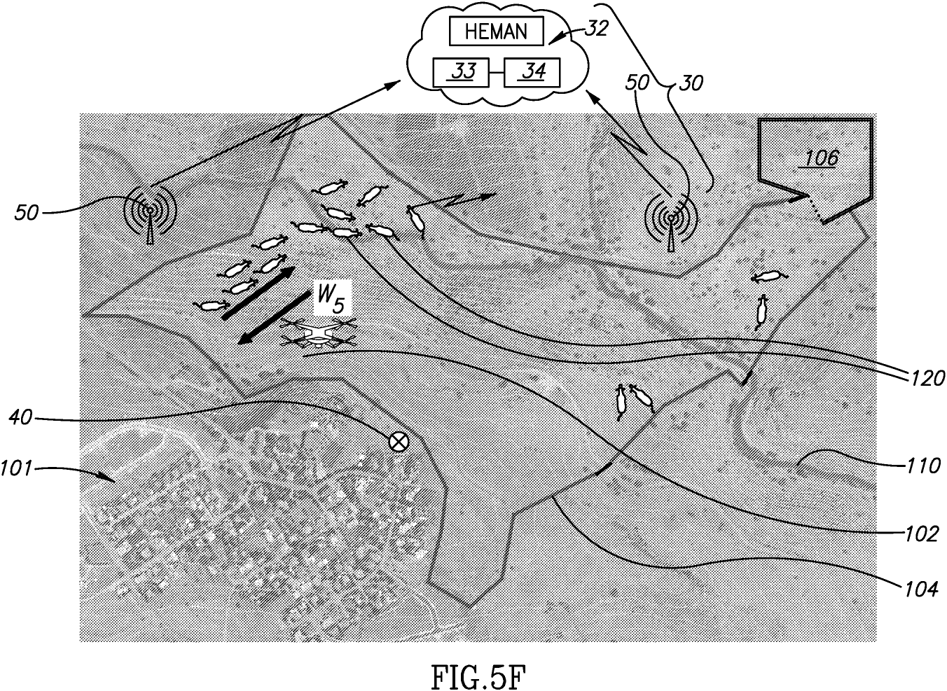

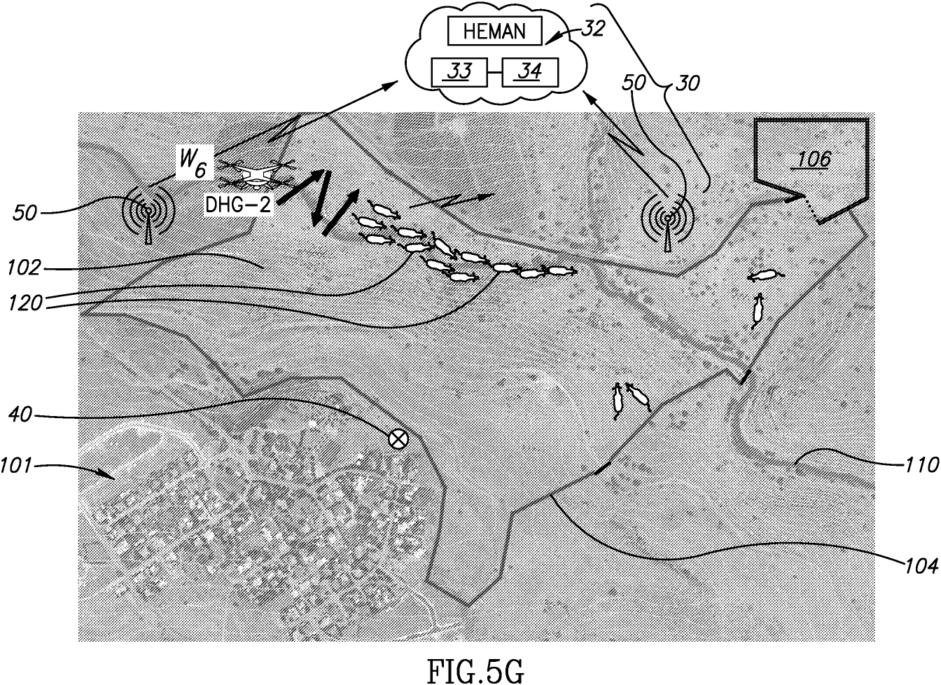

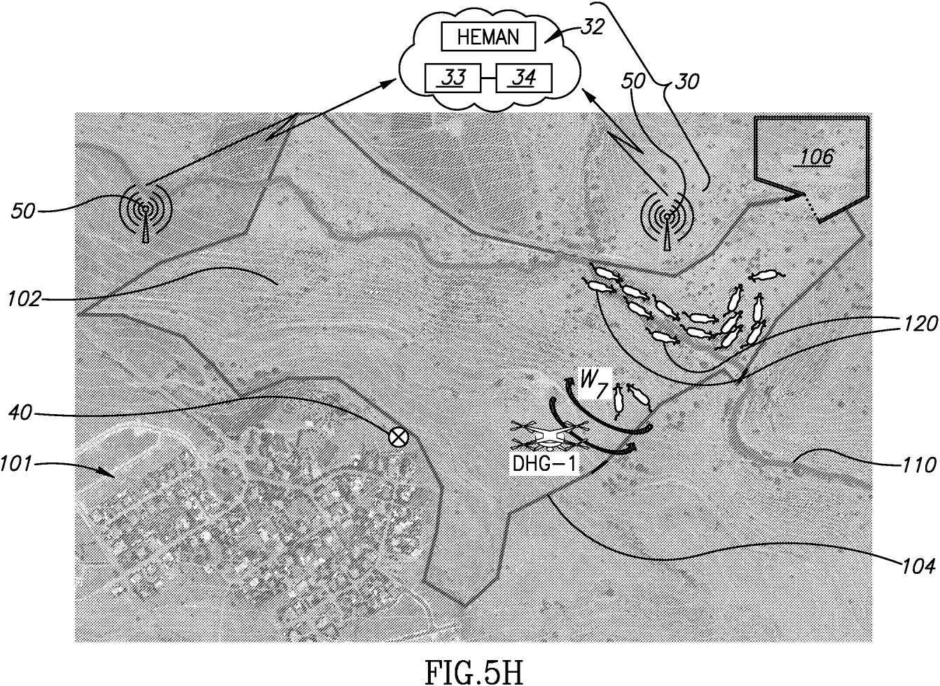

FIGS. 5A-5H schematically illustrate a HeMan drone cowboy 80 dispatched by HeMan 30 to drive herding animals 120 along herding plan route 220 shown in FIG. 4 to corral 106, in accordance with an embodiment of the disclosure. FIGS. 5A-5H show schematic snapshots of the locations of herd animals 120 when drone cowboy is substantially located at waypoints W₁ - W₇. Drone cowboy starts herding animals 120 at the first waypoint W₁ at a starting location of herding route 220 shown in FIGS. 5A and 5B. FIG. 5A schematically shows drone cowboy 80 at W₁ performing the clustering gesture DHG-1 to cluster three animals 120 located in a pocket of GROI 100 in the neighborhood of W₁. FIG. 5B schematically shows drone cowboy 80 still located substantially at waypoint W₁ but now executing the “forward” gesture DHG-2 to drive the three clustered animals out from the “pocket”. FIG. 5C schematically shows drone cowboy 80 at W₂ performing the left turn gesture DHG-5 to move animals 120 away from the steep gradient region 108 (FIG. 2) and move along fence 104. In FIGS. 5D and 5E at waypoints W₃ and W₄ the drone cowboy uses the forward gesture DHG-2 to keep animals 120 moving along cattle fence 104. At W₅ drone cowboy 80 gestures a back and forth “no entry gesture” to keep herd animals 120 moving along cattle fence 104 and prevent the animals from moving into the steep gradient area 108 (FIG. 2). At waypoint W₆ drone cowboy gestures DHG-2 to move animals 120 forward along stream 110 towards corral 106. At W₇ the HeMan drone cowboy gestures at two animals 120 with clustering gesture DHG-1 to move the two animals to join the rest of herd animals 120 and move towards corral 106.

Descriptions of embodiments are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the invention is limited only by the claims.

1. A system for herding herd animals, the system (30) comprising:
a database having a library of drone herding gestures (DHG-1, DHG-2,...DHG-8) each herding gesture comprising software useable to control a drone to perform a different predetermined aerobatic maneuver, each maneuver defined at least by a formatted flight pattern, altitude, and direction referenced to a location, of a herd of animals (120) and configured to elicit a particular type of movement by the herd or an animal in the herd;
at least one drone; and
at least one controller comprising a processor (34) operable to use the software to control the at least one drone to perform a drone herding gesture of the drone herding gestures in the library to control the herd and carry out a herding assignment (220).

2. The system according to claim 1 wherein the drone herding gesture comprises at least one or any combination of more than one acoustic gesture selected from a barking noise made by a dog, a vocalization made by a cowboy, or an artificial noise made to herd an animal or animals.

3. The system according to claim 1 wherein the at least one drone comprises a speaker controllable to execute the acoustic gesture.

4. The system according to claim 1 wherein the drone herding gesture comprises an optical gesture including a visual light stimulus configured to elicit a desired response from a herd or herd animal.

5. (canceled)

6. The system according to claim 1 wherein the herding assignment comprises spatial coordinates of a destination and a desired time of arrival at the destination.

7. (canceled)

8. The system according to claim 1 wherein the herding assignment comprises locations of members of the herd at initiation and during execution of the herding assignment in a terrain over which the at least one drone is intended to fly to carry out the herding assignment.

9. The system according to claim 8 wherein the herding assignment comprises a terrain map of the terrain.

10. The system according to claim 9 wherein the members of the herd are tagged with a Global Navigation Satellite System (GNSS) receiver and/or an inertial measurement unit (IMU) that determines at least one of the locations of the herd members and a transmitter for wirelessly transmitting the at least one location to provide the system with the location.

11. The system according to claim 1 wherein the at least one drone comprises a camera operable to acquire images of the herd and the terrain over which the at least one drone flies during execution of the herding assignment.

12. The system according to claim 11 wherein the processor processes the images to determine a least one location of the locations of the herd members.

13. The system according to claim 1 wherein the herding assignment comprises a flight path that the at least one drone flies during execution of the herding assignment.

14. (canceled)

15. The system according to claim 13 wherein at least a portion of the flight path is determined dynamically substantially in real time during execution of the herding assignment responsive to locations of herd members during execution of the herding assignment.

16. The system according to claim 13 wherein the flight path comprises at least one waypoint (W₁-W₇) along the flight path at which the at least one drone performs a drone herding gesture selected from the plurality of drone herding gestures in the library to execute the herding assignment.

17. (canceled)

18. The system according to claim 16 wherein a waypoint (W₁-W₇) of the at least one waypoint is dynamically determined substantially in real time during execution of the herding assignment responsive to the locations of the herd members and characteristics of the terrain at the locations.

19. The system according to claim 16 wherein the drone herding gesture performed at the waypoint is predetermined.

20. The system according to claim 16 wherein the drone herding gesture performed at the waypoint is dynamically selected substantially in real time during execution of the herding assignment responsive to the locations of the herd members and characteristics of the terrain in a neighborhood of the waypoint.

21. The system according to claim 16 and comprising a neural network trained to select the drone herding gesture for the waypoint of the at least one waypoint from the library to provide a desired movement of a member or members of the herd at the waypoint.

22. (canceled)

23. The system according to claim 1 and comprising a control and data hub comprising a controller of the at least one controller that communicates with the at least one drone to cooperate in executing the herding assignment.

24. The system according to claim 1 wherein the at least one drone comprises a plurality of drones that operate as a swarm to execute the herding assignment.

25. The system according to claim 1 and configured to operate autonomously to execute at least a portion of the herding assignment.
